(19) United States
(12) Patent Application Publication
(10) Pub. No.: US 2014/0039746 A1
(43) Pub. Date: Feb. 6, 2014

(54) CONTROL UNIT FOR CONTROLLING THE OPERATION OF A MOTOR VEHICLE WITH AN ELECTRIC MOTOR AND A MOTOR VEHICLE

(71) Applicants: Martin Geissenhöner, Ingolstadt (DE); Alexander Kruse, Ingolstadt (DE); Martin Bauer, Ingolstadt (DE); Andreas Muigg, Ingolstadt (DE)

(72) Inventors: Martin Geissenhöner, Ingolstadt (DE); Alexander Kruse, Ingolstadt (DE); Martin Bauer, Ingolstadt (DE); Andreas Muigg, Ingolstadt (DE)

(21) Appl. No.: 14/113,945

(22) PCT Filed: Apr. 16, 2012
(86) PCT No.: PCT/EP2012/001642

§ 371 Date: Oct. 25, 2013

(30) Foreign Application Priority Data
Apr. 28, 2011 (DE) 10 2011 018 875.4

(51) Int. Cl. B60W 10/08; B60W 10/10

(52) U.S. Cl. CPC B60W 10/08; B60W 10/10
USPC 701/22

(57) ABSTRACT

A control device for controlling operation of a motor vehicle having an electric motor in at least three operating states. In a first operating state, the motor vehicle is off; in a second operating state, the motor vehicle is on and the electric motor is not controllable; and in a third operating state, the motor vehicle is on and the electric motor is in operation. The control unit includes a basic control element for turning the motor vehicle on and off, and a gear-shift control element for selecting a gear-shift stage. The motor vehicle can be switched from a first operating state to a second operating state by a signal from the basic control element when the motor vehicle is turned on, and from the second operating state to the third operating state with the gear-shift control element by selecting a gear-shift stage associated with the third operating state.

The invention relates to a control unit for controlling the operation of a motor vehicle with an electric motor with respect to at least three operating states, wherein the motor vehicle is turned off in a first operating state, the motor vehicle is turned on in a second operating state while the electric motor cannot be controlled, and the motor vehicle is turned on in a third operating state and the electric motor is operating. The invention also relates to a motor vehicle having such a control unit.

It is known that three different positions of a control unit, for example an ignition key, can typically be used in motor vehicles with an internal combustion engine. In addition simply turning on the vehicle, wherein systems operable by the operator, such as infotainment systems and the like can be controlled, the engine can be started, for example by further turning of an ignition key. Various control units based on such concept are also known in other modern systems, wherein the operator needs only have the key with him which is then detected automatically wirelessly. Generally it is fair to say that in motor vehicles with an internal combustion engine, the operator request, for example starting the motor vehicle, turning the motor vehicle off and the like, is conveyed by an intentional control action, which can then be verified by the feedback from the internal combustion engine.

In motor vehicles with an electric motor, particularly in hybrid vehicles, wherein initially only the electric motor is used at low speed, the acoustic feedback from the engine is lacking, so that the different operating states of the motor vehicle are no longer distinct for an operator. Accordingly, a plurality of operating states exist which the operator has difficulty to separating from each other.

Conventional vehicles have another significant disadvantage in that to start the motor vehicle, independently of the gear set in the automatic transmission, not only the control element, with which the motor vehicle is turned on, must be operated, but another operating action must also be performed, usually applying the brake with the brake pedal. Moreover, such known control units are ultimately implausible, because it remains unclear to the operator whether the electric motor is operating or not due to the lack of acoustic feedback. This results in additional dangerous situations, such as the danger of leaving the vehicle while the drive motor is still running, so that the motor vehicle may start moving on its own, or a battery may be discharged because the motor vehicle is permanently energized.

It is therefore an object of the invention to provide an improved control unit and an improved motor vehicle which allows a more intuitive, easier and more transparent control.

This object is attained according to the invention with a control unit of the aforementioned type in that the control unit includes a basic control element for turning the motor vehicle on and off and a gear-shift control element for selecting a gear ratio, wherein the motor vehicle can be switched from the first operating state into the second operating state solely by a signal from the basic control element when the motor vehicle is started, and wherein the motor vehicle is switched from the second operating state into the third operating state by operating the gear-shift control element through selection of a gear-shift stage associated with the third operating state.

Thus, with the invention, an entirely new operating concept is proposed, wherein the motor vehicle is initially turned on and off by using only one dedicated control element, for example a wirelessly transmitting key, which the operator must carry with him, such as a one-way pushbutton. Because by turning the motor vehicle on, the motor vehicle is never transferred into a state where the electric motor can be controlled by control actions from the operator, in particular the gas pedal, or inherently produces an driving power, only the actuation of the basic control element is sufficient to turn the motor vehicle on. It is no longer necessary to operate another control element, so that the motor vehicle can be turned on with the basic control element, without having to simultaneously actuate another control element, in particular without having to simultaneously engage the brake via the brake pedal.

By operating exclusively the basic control element of the motor vehicle to turn the vehicle on, the motor vehicle thus assumes the second operating state, wherein the electric motor can neither be controlled and the electric motor does not supply a driving force for the motor vehicle. In a specific embodiment, only a parking gear-shift stage (P-stage) and a neutral gear-shift stage (N-stage) can be active in the second operating state the motor vehicle. While the electric motor may conceivably already be ready to operate in the N-stage, in particular when using electric motors having permanent magnets, the electric motor is, of course, always disengaged, so that it does not cause the motor vehicle to move and cannot be actuated via the gas pedal. Consequently, the second operating state which can be comfortably attained by operating the basic control element can still be regarded as safe, so that additional control elements need not be queried for safety reasons.

The basic control element advantageously has a clearly understandable and conveyable meaning, because it is associated with the vehicle states “turned on” and “turned off”. The operator therefore clearly understands the changes he initiates by operating the basic control unit, thereby reducing the confusing variety of vehicle states.

When the operator wishes to actually start driving, the gear-shift control element, such as a shift lever, must be used to select a gear-shift stage that is associated with the above-defined third operating state of the motor vehicle in which the electric motor is controllable and/or is in a state configured to drive the vehicle. It may be required for operating the gear-shift control element to positively operate another control element, such as a brake pedal, before being finally able to start driving. This leads to an overall simpler operation for starting the motor vehicle, because the ready-to-drive state can be achieved in the on-state of the motor vehicle, i.e. in the second operating state, by engaging a driving level as a gear-shift stage.

The operator can thus select between an off-state of the motor vehicle, in which at most vehicle systems imperceptible to the operator are active, for example key monitoring, and an on-state of the motor vehicle, in which all systems (apart from the motor itself), in particular the air-conditioning and/or infotainment systems and/or a navigation system, can be operated. The operator can also infer that he can attain a ready-to-drive state only, after the motor vehicle has been turned on, when a driving level is engaged.

In another embodiment of the present invention, a parking gear-shift stage and a neutral gear-shift stage may be associated as a gear-shift stage in the motor vehicle with the first and the second operating state, and at least one forward gear stage and a reverse gear stage may be associated with the third operating state. As is customary with an automatic transmission, the gear-shift stages are initially provided as a parking gear-shift stage and a neutral gear-shift stage (frequently referred to as P-gear-shift stage and N-gear-shift stage), where it is known that the electric motor cannot be controlled. In the parking gear-shift stage, the vehicle is actually locked, meaning that the transmission is blocked and/or a hand brake, in particular an electric parking brake, is applied. Moreover, as will be discussed in more detail below, the park-gear-shift stage may advantageously be realized by the engaging an exclusively installed electric parking brake. The motor vehicle is thus safely parked in the parking gear-shift stage. Nevertheless, the neutral gear stage is typically also permitted when the motor vehicle is turned off, because the motor vehicle should be allowed to continue rolling, for example, in car washes or when the vehicle is towed, even though the motor vehicle is turned off. In this way, the engaged gear-shift stage remains engaged even when the motor vehicle is started by using the basic control element when the engaged gear-shift stage was the parking gear stage or the neutral gear-shift stage before the motor vehicle was turned on, meaning that the parking gear-shift stage and the neutral gear-shift stage remain in effect when the vehicle is started. The operator is then not confused.

Furthermore, as is common with automatic transmissions, at least one forward driving stage (frequently also Drive driving-stage or D-stage) and one reverse driving stage (R-driving stage) are present, which are associated with the ready-to-drive motor vehicle and hence with the third operating state. If the motor vehicle is switched into the forward driving stage or the reverse driving stage while the motor vehicle is turned on, optionally while simultaneously depressing the brake pedal, the motor vehicle changes into the third operation state. The vehicle is then ready to drive.

It should be emphasized again at this point that the motor vehicle can only be in the parking gear-shift stage or the neutral gear-shift stage when starting up.

According to another, particularly advantageous embodiment of the present invention, the gear-shift control element may be constructed as a shift lever configured to return to a basic position, in particular a position indicative of a neutral gear-shift stage, when switching to a gear-shift stage associated with a third operating state. Accordingly, for example, a so-called “tipping”, i.e. not latching shift lever may be provided which returns to a basic position. In this way, no problems or confusion occur when the shift lever would still be latched in a gear-shift stage associated with the third operating state. This configuration can be particularly advantageously combined with a configuration wherein the parking gear-shift stage is no longer selected via the gear-shift control element, but for example via an additional button or another two-way control element. The tipping gear-shift control element can the be used much like a Tiptronic gear shift for switching between the neutral gear-shift stage and the driving stages, whereas the motor vehicle is secured with the parking control unit, as was the case with the parking brake in older vehicles, wherein the parking control unit is in particular designed as a two-way control element. This can be combined with a configuration wherein the parking gear-shift stage is realized with an electric parking brake (EPB). In other words, there is no longer a duplicate protection of the motor vehicle through competing systems, because the parking gear-shift stage for safely parking the motor vehicle is realized as a central safety system by engaging the EPB and a built-in dedicated parking control element.

As mentioned above, it may be useful for safety reasons when simultaneously a brake pedal must be operated in a driving stage associated with the third operating state. These safety measures are frequently required when the motor vehicle is to be placed in a ready-to-drive state.

In another advantageous embodiment of the present invention, the control unit may have at least one basic display unit, particularly a display unit integrated into the basic control unit, for displaying when the motor vehicle is turned on or turned off. Advantageously, the basic control element itself provides direct feedback to the operator as to whether the motor vehicle is turned on or turned off. This may be realized, for example, with suitable red or green backlighting; however, backlit text or other visual displays are also feasible. Thus, the operator receives clear feedback about the operating states of the motor vehicle, in this case mainly with respect to the turned-on or turned-off state of the motor vehicle.

Additionally or alternatively, the control unit may include at least one power display device which is configured to display a power level of the motor vehicle depending on the turn-on state of the motor vehicle and/or an engaged gear-shift stage. This also significantly improves the information for the operator. In an actual advantageous embodiment of the power display device, this device may be configured to display three power levels, with the first power level corresponding to the first mode, the second power level corresponding to the turned-on motor vehicle with the electric motor not operational, in particular not powered, and the third power level corresponding to the turned-on motor vehicle with an operational electric motor. Such “power meter” capable of visualizing the different power levels, for example, in red or without color-coding for the first power level, in yellow for the second power level and in green for the third power level, enhances the intelligibility of the vehicle state, in particular with regard to the electric motor, which is often already activated even in the neutral gear-shift stage, in particular when zero torque is required. Additionally, latencies should be avoided, especially when there is an “N-transition”, i.e. shifting through the neutral gear stage, by switching the electric motor for a short time into a state where it is not operational. When expressing the display principle of the power display device of this particular embodiment with the different possible gear-shift stages, then basically no power is displayed when the vehicle is completely turned off. When the vehicle is turned on and the parking gear-shift stage is active, an average power consumption is shown in yellow. When the motor vehicle is turned on and the neutral gear-shift stage, a forward drive stage or the reverse stage is active, it is indicated that the motor vehicle at maximum power.

As already mentioned, a parking control element may be provided for activating and/or deactivating the parking gear-shift stage. As mentioned above, such a configuration can advantageously be realized by implementing the parking shift as an electric parking brake control element and by preventing the gear-shift control element from actuating the parking gear stage. It should be noted that several parking control elements may be provided, for example a lever resembling a hand brake and a switch arranged for example on the side of the lever.

Furthermore, a shift into a neutral gear-shift stage may be made during release of the parking gear-shift stage in the second operating mode, however in particular only when a brake control element, in particular the brake pedal is simultaneously actuated. When releasing of the parking gear-shift stage, it may be required for safety reasons to simultaneously depress a brake pedal or the like.

When turning off the motor vehicle, the behavior of the control unit should be selected mainly so that the actual state of the motor vehicle is observed as well as the fact that a parking gear-shift stage or a neutral gear-shift stage is engaged in the subsequent first operating state in a transparent manner. In a specific embodiment of the present invention, when a signal is transmitted from the basic control element for turning the motor vehicle off:
when the motor vehicle is in the third operating state and is stationary, the motor vehicle can be switched into the first operating state and/or into an intermediate state before the first operating state, when the parking gear-shift stage and/or an electric parking brake is engaged,
when the motor vehicle is in the third operating state and is moving, in particular only in the presence of a continuous signal and/or a signal that is repeated several times in a predetermined time interval, the motor vehicle is can be switched into the first operating state, with the brake and steering being active until the motor vehicle stops, and/or into an intermediate state before the first operating state with an engaged neutral gear-shift stage, and
when the motor vehicle is in the second operating state, the motor vehicle, is switched into the first operating state and/or into an intermediate state before the first operating state while maintaining an engaged gear stage, in particular the neutral gear-shift stage and the park gear-shift stage.

Therefore, an intermediate state enhancing the comfort for an operator may be provided, wherein in a specific embodiment of the present invention the intermediate state may be provided as an additional operating state of the motor vehicle where not all of the systems of the motor vehicle are switched on, wherein the motor vehicle can be switched from the intermediate state into the first operating state with an additional operator element, in particular by opening a driver-side door. For example, with respect to the intermediate state, initially infotainment systems may still be operated in the intermediate state, whereas the air conditioner is turned off. The motor vehicle is completely transferred into the first operating state only when the driver-side door is opened and/or is closed again. This adds comfort for the operator, if he wishes, for example, to finish reading something in the infotainment system before exiting the vehicle. Only when exiting the vehicle does it become clear that the operator wishes to leave the vehicle, so that the vehicle can be completely switched off, i.e. transferred into the first operating state.

Regardless of whether such intermediate state is provided, several possibilities exist for transferring the vehicle from the second or third operating state back into the first operating state. When the motor vehicle is stationary, i.e. when it is not driven, the vehicle can ultimately be turned off directly by actuating the basic control element, wherein the currently engaged gear-shift stage, corresponding to the first or second operating state, is maintained. When a driving stage associated with the third operational state is currently engaged, the vehicle is advantageously secured by shifting into the parking gear-shift stage, when the motor vehicle is transferred into the first operating state. However, the motor vehicle may also be deactivated, i.e. turned off, while moving. Under these circumstances, it may make sense to place increased demand on the operation of the basic control element, so that it must be kept pressed, for example, for a predetermined time period and/or must be actuated several times within a predetermined time period in order to transfer the motor vehicle into the first operating state, i.e. to turn the motor vehicle off. Advantageously, the steering system and braking system then continue to be available to the operator and the motor vehicle is switched into the neutral gear-shift stage. The steering system and brake system then operate as usual until the vehicle has come to a standstill.

In addition to the control unit, the present invention also relates to a motor vehicle with an electric motor and a control device according to the invention. All descriptions with respect to the control unit according to the invention can be applied similarly to the motor vehicle according to the invention, so that the motor vehicle attains the same the advantages as the control unit according to the invention.

As has already described in detail above, such motor vehicle may be characterized in that the parking gear-shift stage is implemented using an electric parking brake. Therefore, no competing systems are needed to keep the vehicle in a safe condition. In this context, a gear-shift control element that lacks the option to select the park gear-shift stage may be used. Instead, as previously described, a parking control element may be used, for example a two-way control element.

Further advantages and details of the present invention will become apparent from the following described exemplary embodiments and the drawings, which show in:

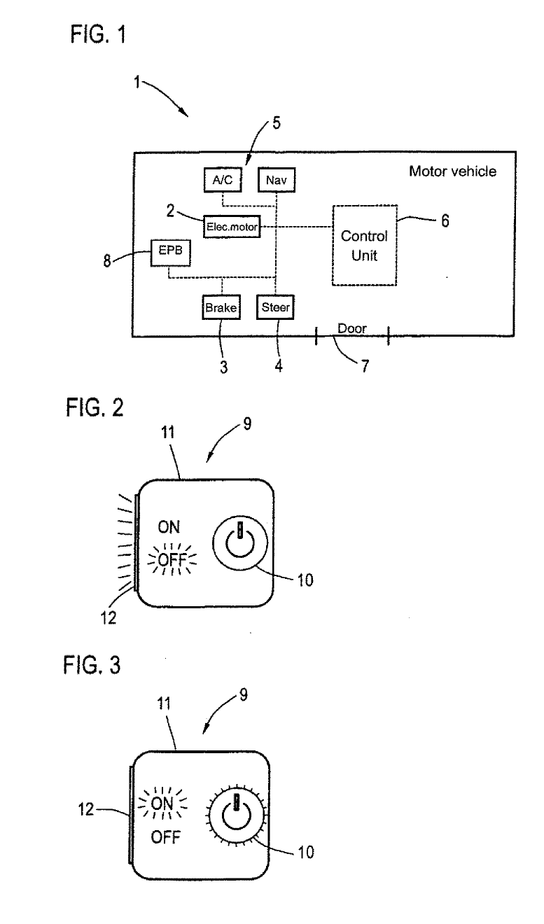

FIG. 1 a schematic diagram of a motor vehicle according to the present invention,

FIG. 2 a basic control element of the control unit in the off-state,

FIG. 3 the basic control element of FIG. 2 in the on-state,

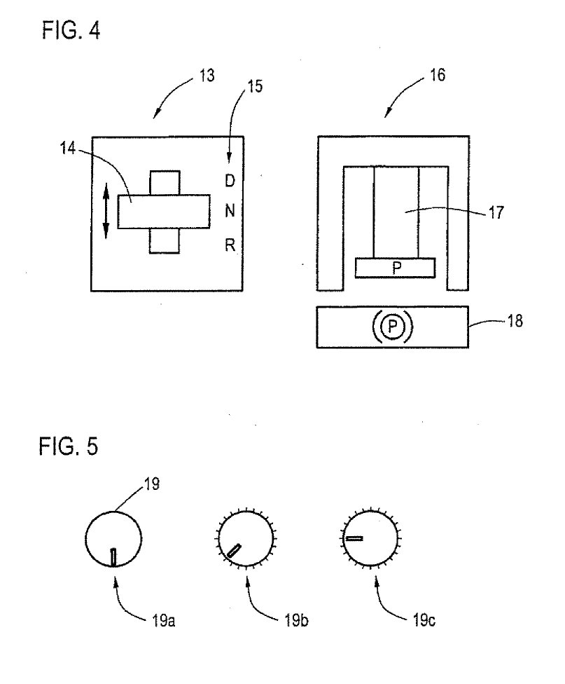

FIG. 4 a gear-shift control element and a parking control element,

FIG. 5 possible displays of a power display unit,

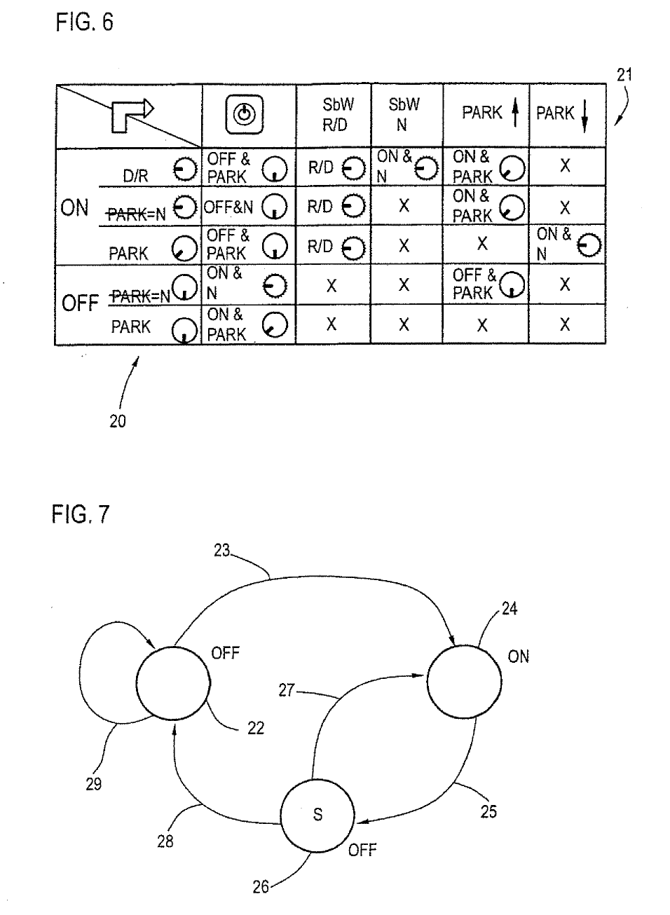

FIG. 6 a table showing shifting options,

FIG. 7 a control diagram of another embodiment of the control unit according to the present invention, and

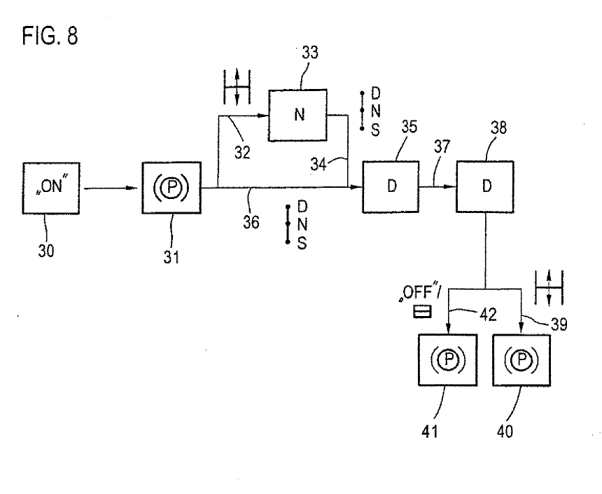

FIG. 8 a possible control flow diagram.

FIG. 1 shows a schematic diagram of a motor vehicle 1 according to the invention. The motor vehicle 1 includes an electric motor 2 and consequently is an electric vehicle or a hybrid vehicle. Other vehicle systems in addition to a brake system 3 and a steering system 4 are indicated with 5, for example an air conditioning system, an infotainment system, a navigation system and the like. The motor vehicle further includes an only schematically illustrated control unit 6 according to the invention with which the operation of the motor vehicle 1 can be controlled. A driver-side door 7 allows the operator to enter and exit.

In the illustrated motor vehicle, the transmission is not blocked in a parking gear-shift stage; instead, the parking gear-shift stage is realized with an electric parking brake 8 (EPB).

The control unit 6 includes a basic control element 9, which is used for turning the motor vehicle 1 on and off and which may be configured, for example, as shown in FIGS. 2 and 3. The basic control element 9 has a one-way button 10, which in this example is integrated with a basic display device 11. When the motor vehicle 1 is in an off state, hereinafter referred to as the first operating state, the message “OFF” is backlit by the display device 11, and a lateral red illumination is also produces by a display element 12.

When the button 10 is operated (when presence of a key carried by the operator is detected), the motor vehicle 1 is turned on, i.e. transferred into a second operating state in which it is however not yet ready-to-drive. For transferring the motor vehicle in the second operating state, in which the electric motor 2 cannot yet be controlled, the signal exclusively from the basic control element 9 is sufficient to turn the motor vehicle on, meaning that no additional control element needs to be activated. As shown in FIG. 3, the switch 10 is backlit in green in the second operating state of the motor vehicle as well as in the third, ready-to-drive operating state. Moreover, the script “ON” is highlighted in green.

FIG. 4 shows as additional control elements of the control unit 6 a gear-shift control element 13, here a shift lever 14 formed as a tip lever, i.e. it always returns to a center position after a gear-shift, wherein the engaged gear-shift stage is visualized on a shift display device 15. Accordingly, a kind Tiptronic gear-shift is formed. However, the parking gear-shift stage (P) cannot be selected via the gear-shift control element 13. Because, as already described with respect to FIG. 1, the functionality is combined with the electric parking brake 8, a separate parking control element 16 is provided therefor, which in this example includes a lever 17 enclosed in a housing, wherein the lever 17 can be moved between the two positions to activate and deactivate the parking gear-shift stage. To display the parking gear-shift stage, a parking display device 18 is provided wherein a symbol is backlit as soon as the electric parking brake 8 is engaged, i.e. the motor vehicle 1 is in the parking gear-shift stage. However, other embodiments are also feasible wherein another parking control element is provided, for example a button, in addition to the lever 17. To release the parking control element, i.e. to turn the parking gear-shift stage off, the unillustrated brake pedal must still be actuated. This even applies when the vehicle is to be switched from the second operating state, with which the neutral gear stage (N) stage and the parking shift stage are associated, into an actual driving stage as a gear-shift stage, in particular a forward driving stage (D-stage) or a reverse driving stage (R-stage). By engaging the forward driving stage associated with the third operating state or the reverse driving stage, the motor vehicle 1 is moreover switched into the third operating state, in which the motor vehicle is ready-to-drive and the electric motor 2 is operational and operated.

FIG. 5 shows several display states of a power display device 19, which also forms part of the control unit 6. The state 19a indicates that the motor vehicle is turned off. The state 19b, backlit in yellow, is an intermediate position indicating that although the motor vehicle 1 is turned on, the electric motor 2 is not yet energized, as the case here in the parking gear-shift stage.

The state 19c, which is backlit in green, indicates that the full power of the motor vehicle 1 is available, i.e. the electric motor 2 is energized. This display is obtained when the vehicle 1 is turned on and is in the neutral gear-shift stage, a forward gear-shift stage or the reverse gear-shift stage.

FIG. 6 shows in form of an overview how the motor vehicle 1 is to be switched according to one embodiment of the control unit 6. Here, the initial states of the motor vehicle 1 are shown in the vertical column 20, a control action via the control unit 6 is shown in the horizontal row 21. In addition, the displays of the power display device 19 are still shown. In FIG. 6:
ON designates a turned-on motor vehicle 1,
OFF designates a turned-off motor vehicle 1,
D/R designates the forward driving stage (D-stage) and the reverse driving stage (R-stage),
N designates neutral gear-shift stage (N-stage),
PARK designates the active parking gear-shift stage,
[symbol] designates the not-engaged parking gear-shift stage (corresponds to the neutral gear-shift stage when the motor vehicle 1 is not driven)
SbW designates actuation of the gear-shift control element,
PARK↑ designates pulling the parking control element 19 (and thus engaging the electric parking brake 8), and
PARK↓ designates releasing (pressing) the parking control element 19 (and thus releasing the electric parking brake 8).

It should be noted here again that in this embodiment a brake pedal operation is also required in addition to actuating the gear-shift control element 13 into a forward driving stage or into the reverse driving stage, and also in addition to releasing the parking gear-shift stage.

An “x” in FIG. 6 indicates that the state does not change.

It should also be noted that the approach illustrated in FIG. 6 can be modified when the basic control element 9 is actuated with an engaged forward driving stage or an engaged reverse driving stage in the event that the motor vehicle 1 is still moving. The vehicle 1 may the only be turned off in response to a recognized control action, namely actuation of the button 10 for a predetermined period of time (“long-push”), for example for at least two seconds, and/or actuation of the button 10 multiple times within a predetermined period of time. However, the motor vehicle is not turned off immediately and transferred into the parking shift stage, as shown in FIG. 6; instead, as long as the motor vehicle 1 is still moving, it is indeed switched off, but the neutral gear-shift stage is engaged and the brake system 3 and the steering system 4 remain active until the motor vehicle stops. Only then is the parking gear-shift stage automatically engaged.

It should also be noted that the illustrated control concept can also be combined with a so-called auto-park function. If the driver-side door 7 is opened, while the motor vehicle 1 is turned on and the neutral gear-shift stage or a driving stage is engaged, the motor vehicle 1 is automatically transferred into the parking gear-shift stage. The electric parking brake is applied. However, it is possible to engage again a driving step via the gear-shift control element 13 so as to be able to maneuver with the door open.

FIG. 7 shows a schematic flow diagram for controlling the motor vehicle 1 with the control unit 6, if an additional intermediate state S is provided in another embodiment, in which only a few vehicle systems 5 can be operated, for example only the infotainment system. When the motor vehicle 1 turned off, circle 22, actuating the basic control element 9 according to the arrow 23 leads to the second operating mode, circle 24, from where, for example, the third operating state can be attained, as already described, and the like. All this is meant to be included in the circle-24. The motor vehicle 1 is turned on, meaning that all vehicle systems (apart from the electric motor in the second operating state) are ready to operate.

However, when the basic control element 9 is now operated again, arrow 25, the first operating state is not reached directly, but first an intermediate state symbolized by the circle 26. Some systems, such as air conditioning, are not operable in this intermediate state, whereas the infotainment system continues to operate. Nevertheless, this state is already indicated as “OFF”. When the basic control element 9 is actuated again in the intermediate state, arrow 27, the motor vehicle 1 is again transferred into the second operating state, i.e. turned on.

The first operating state, i.e. where the motor vehicle 1 is turned off, is hereby reached from the intermediate state by opening the driver-side door 7, see arrow 28. When the driver-side door 7 is then opened again, arrow 29, nothing changes.

Lastly, FIG. 8 shows a flowchart of a possible operation via the control unit 6 according to the invention. It will be assumed that the motor vehicle 1 is first turned on via the basic control element 9, box 30, so that the motor vehicle 1 is initially in the parking gear-shift stage 31 in the second operating state, box 31. When, the operator now actuates the parking control element 16 together with the brake pedal according to the arrow 32, the motor vehicle enters the rollable state shown in box 33, where the neutral gear-shift is engaged. From here, the operator can engage a forward driving stage according to box 35 by actuating the gear-shift control element 13, arrow 34; however, the brake pedal must again be simultaneously depressed. The state in box 35 can be reached directly from the state in box 31 according to the arrow 36 when using the gear-shift control element 13.

A driving stage is thus engaged in box 35 and the motor vehicle 1 is ready-to-drive. The operator can now start according to the arrow 37 and remains as a matter of course in this driving stage while driving, box 38. When the operator wants to finish his travel, he can stop and pull the parking control element 16, arrow 39. The parking gear-shift stage is then engaged, and the motor vehicle I is safely parked, box 40. Likewise, the parking gear-shift stage according to box 41 can also be reached via the arrow 42, namely by actuating the basic control element 9 for turning the motor vehicle 1 off or by opening of the driver-side door 7, when an auto-parking function is provided.

1-14. (canceled)

15. A control unit for controlling operation of a motor vehicle having an electric motor in relation to at least three operating states, wherein in a first operating state the motor vehicle is turned off, in a second operating state the motor vehicle is turned on while the electric motor is not controlled, and in a third operating state the motor vehicle is turned on and the electric motor is in operation, the control unit comprising:
a basic control element for turning the motor vehicle on and off, and
a gear-shift control element for selecting a gear-shift stage,
wherein the motor vehicle is switched from the first operating state into the second operating state exclusively by a signal from the basic control element when the vehicle is turned on, and
wherein the motor vehicle is switched from the second operating state into the third operating state by actuating the gear-shift control element and selecting a gear-shift stage associated with the third operating state.

16. The control unit of claim 15, wherein the motor vehicle comprises as gear-shift stages a parking gear-shift stage and a neutral gear-shift stage, which are associated with the first and the second operating state, and at least one forward driving stage and one reverse driving stage, which are associated with the third operating state.

17. The control unit of claim 15, wherein the gear-shift control element is constructed as a shift lever which is configured to return to a basic position at least when switching into a gear-shift stage associated with the third operating state.

18. The control unit of claim 17, wherein the basic position is a neutral gear-shift stage.

19. The control unit of claim 15, wherein a brake pedal is actuated simultaneously when switching into a gear-shift stage associated with the third operating state.

20. The control unit of claim 15, further comprising at least one basic display device for displaying whether the motor vehicle is turned on or turned off.

21. The control unit of claim 20, wherein the at least one basic display device is integrated in the basic control element.

22. The control unit of claim 15, further comprising at least one power display device configured to display a power level of the motor vehicle as a function of the operating state of the motor vehicle when the motor vehicle is turned on or of an engaged gear-shift stage.

23. The control unit of claim 22, wherein the power display device is configured to display three power levels, wherein the first power level corresponds to the first operating state, the second power level corresponds to a state where the motor vehicle is turned on while the electric motor is not operative, and the third power level corresponds to a state where the motor vehicle is turned on and the electric motor is operative.

24. The control unit of claim 23, wherein when the electric motor is not operative, in the electric motor is not energized.

25. The control unit of claim 16, further comprising a parking control element for at least one of activating and deactivating the parking gear-shift stage.

26. The control unit of claim 16, wherein when the parking gear-shift stage is released in the second mode, the motor vehicle is switched into the neutral gear-shift stage only when a brake control element is simultaneously actuated.

27. The control unit of claim 16, wherein the brake control element is a brake pedal.

28. The control unit of claim 15, wherein the control unit is configured to, when the basic control element sends a control signal to turn the motor vehicle off:
(a) switch into the first operating state or into an intermediate state disposed before the first operating state when a parking gear-shift stage or an electric parking brake is engaged, provided that the motor vehicle is in the third operating state and stationary,
(b) switch into the first operating state, while the brake and steering are active until the motor vehicle comes to a standstill, or switch into an intermediate state disposed before the first operating state while the neutral gear-shift stage is engaged, provided that the motor vehicle is in the third operating state and moving, and
(c) switch into the first operating state or into an intermediate state disposed before the first operating state, while maintaining an engaged gear-shift stage, provided that the motor vehicle is in the second operating state.

29. The control unit of claim 28, wherein switching in (b) takes place only in presence of a prolonged signal or a signal that is repeated several times in a predetermined time interval.

30. The control unit of claim 28, wherein the engaged gear-shift stage is a neutral gear-shift stage and a parking gear-shift stage.

31. The control unit of claim 28, wherein the intermediate state is an operating state of the motor vehicle in which not all systems of the motor vehicle are turned on, the control unit further comprising an additional control element configured to switch from the intermediate state into the first operating state.

32. The control unit of claim 31, wherein the additional control element is responsive to a driver-side door being opened.

33. A motor vehicle comprising an electric motor and a control unit for controlling operation of a motor vehicle in relation to at least three operating states, wherein in a first operating state the motor vehicle is turned off, in a second operating state the motor vehicle is turned on while the electric motor is not controlled, and in a third operating state the motor vehicle is turned on and the electric motor is in operation, wherein the control unit comprises a basic control element for turning the motor vehicle on and off, and a gear-shift control element for selecting a gear-shift stage,
wherein the motor vehicle is switched from the first operating state into the second operating state exclusively by a signal from the basic control element when the vehicle is turned on, and
wherein the motor vehicle is switched from the second operating state into the third operating state by actuating the gear-shift control element and selecting a gear-shift stage associated with the third operating state.

34. The motor vehicle of claim 33, further comprising as gear-shift stage a parking gear-shift stage constructed with an electric parking brake.

35. The motor vehicle of claim 34, further comprising a shift lever which is incapable of selecting the parking gear-shift stage.
